(19) United States
(12) Patent Application Publication
(10) Pub. No.: US 2021/0254559 A1
(43) Pub. Date: Aug. 19, 2021

(54) EXHAUST VALVE DEVICE FOR VEHICLE

(71) Applicant: MIKUNI CORPORATION, Tokyo (JP)

(72) Inventors: Toshiaki ISHII, Odawara (JP); Makoto KOYAMA, Odawara (JP); Daisuke TAKAYAMA, Odawara (JP); Naoki TANAKA, Odawara (JP)

(73) Assignee: MIKUNI CORPORATION, Tokyo (JP)

(21) Appl. No.: 17/154,684

(22) Filed: Jan. 21, 2021

(30) Foreign Application Priority Data
Feb. 14, 2020 (JP) 2020-023455

(51) Int. Cl. F02D 9/04; F02M 26/54

(52) U.S. Cl. CPC F02D 9/04; F02M 26/70; F02M 26/54

(57) ABSTRACT

Provided is an exhaust valve device 1 for a vehicle in which a valve element 7 is supported to be able to be opened and closed in an exhaust passage 4 by a rotating shaft 5 axially supported by a valve body 3, a motor unit 13 is attached to the valve body 3 via a thermal insulation bracket 11, and an output shaft 13a of the motor unit 13 is coupled to the rotating shaft 5, the exhaust valve device 1 including: an outer circumferential, guide surface 10a provided at the valve body 3 and having an arc shape around an axial line C of the rotating shaft 5 at the center; and an inner circumferential guide surface 12a provided at the thermal insulation bracket 11 and brought into slide contact with the outer circumferential guide surface 10a to guide the thermal insulation bracket 11 to be secured at a prescribed securing angle to the valve body 3 around the axial line C of the rotating shaft 5 at the center.

### BACKGROUND OF THE INVENTION

### Field of the Invention

The present invention relates to an exhaust valve device for a vehicle.

Description of the Related Art

Exhaust valve devices may be provided in exhaust pipes of engines mounted in four-wheel vehicles and two-wheel vehicles and are used for various purposes such as exhaust noise reduction and early warming-up of engines through exhaust pressure boosting. For example, each of the exhaust valve devices disclosed in Japanese Patent Laid-Open Nos. 2018-151067 and 2019-120252 is adapted such that an upstream side and a downstream side of an exhaust pipe of an engine are caused to communicate with each other via an exhaust passage formed in a valve body and a valve element is supported to be able to be opened and closed in the exhaust passage by a rotating shaft axially supported by the valve body.

Four engagement pieces are provided respectively on a base portion formed on one side of the valve body to project therefrom, and each engagement piece is fitted into an engagement slit of a bracket disposed on the valve body, thereby securing the bracket to the valve body. A motor unit is secured to the bracket, and an output shaft thereof is coupled to the rotating shaft of the valve body. Thus, if the rotating shaft is turned through driving of the motor unit, then the valve element is opened or closed, and in response to that, exhaust gas distributed through the exhaust pipe is restricted.

Incidentally, since the specification of the exhaust valve device is determined in accordance with various conditions required by a vehicle side (hereinafter, referred to as vehicle-side installation conditions), the specification of the exhaust valve device is changed to adapt to vehicle-side installation conditions required by vehicles in a case in which the exhaust valve device is mounted in different vehicles. Specifically, the valve body may be changed in accordance with an opening diameter of the exhaust pipe of the vehicle, the motor unit may be changed in accordance with a required limit of exhaust gas, or an angle at which the motor unit is secured to the valve body may be changed in accordance with an installation space in the periphery of the exhaust pipe. Since the securing structure with respect to the bracket changes with some specification change in a case in which the valve body or the motor unit is changed, a need to newly produce the entire bracket occurs in accordance with the change.

On the other hand, in a case where the angle at which the motor unit is secured to the valve body is changed, it is possible to use the same members for both the valve body and the motor unit since the specifications thereof do not change. However, there are no other ways than changing the position of the engagement slit on the side of the bracket relative to the engagement piece on the side of the valve body according to the techniques in Japanese Patent Laid-Open Nos. 2018-151067 and 2019-120252 in order to address the new securing angle. Thus, a need to newly produce the entire bracket occurs similarly to the aforementioned other case, and there is a problem of a sudden increase in manufacturing costs.

The present invention was made to solve such a problem, and an object thereof is to provide an exhaust valve device for a vehicle capable of addressing, with a simple specification change, even a case where an angle at which a motor unit is secured to a valve body is changed to mount the exhaust valve device in different vehicles.

### SUMMARY OF THE INVENTION

In order to achieve the aforementioned object, an exhaust valve device for a vehicle of the present invention is an exhaust valve device for a vehicle in which a valve element is supported to be able to be opened and closed in an exhaust passage by a rotating shaft axially supported by a valve body, an actuator is attached to the valve body via a bracket member, and an output shaft of the actuator is coupled to the rotating shaft, the exhaust valve device including: a guide surface provided at one of the valve body and the bracket member and having an arc shape around an axial line of the rotating shaft at the center; and a guide portion provided at, the other one of the valve body and the bracket member and brought into slide contact with the guide surface to guide the bracket member to be secured at a prescribed securing angle to the valve body around the axial line of the rotating shaft at the center.

According to the exhaust valve device for a vehicle of the present invention, it is possible to address, with a simple specification change, even a case where an angle at which the motor unit is secured to the valve body is changed to mount the exhaust valve device in different vehicles.

### BRIEF DESCRIPTION OF THE DRAWINGS

FIG. 1 is a perspective view illustrating an exhaust valve device according to an embodiment;

FIG. 2 is an exploded perspective view illustrating the exhaust valve device;

FIG. 3 is a partially enlarged sectional view illustrating, a bonded location between a valve body and a thermal insulation bracket;

FIG. 4 is an exploded perspective view illustrating a relationship between an outer circumferential guide surface on the side of the valve body and an inner circumferential guide surface on the side of the thermal insulation bracket;

FIG. 5 is an effect explanatory diagram illustrating, in a plan view, a state in which an angle of the thermal insulation bracket with respect to the valve body has been changed;

FIG. 6 is a schematic view illustrating another example in which an outer circumferential surface of a circular projection of the valve body is, used as an outer circumferential guide surface and three guide pins are provided to stand on the side of the thermal insulation bracket;

FIG. 7 is a schematic view illustrating yet another example in which an inner circumferential surface of the circular projection of the valve body is used as an inner circumferential guide surface and three guide pins are provided to stand on the side of the thermal insulation bracket; and

FIG. 8 is a schematic view illustrating yet another example in which the outer circumferential guide surface is formed only in a region into which the guide pins are brought into slide contact.

### DETAILED DESCRIPTION OF THE INVENTION

Hereinafter, an embodiment in which the present invention is implemented as an exhaust valve device for a four-wheel vehicle will be described.

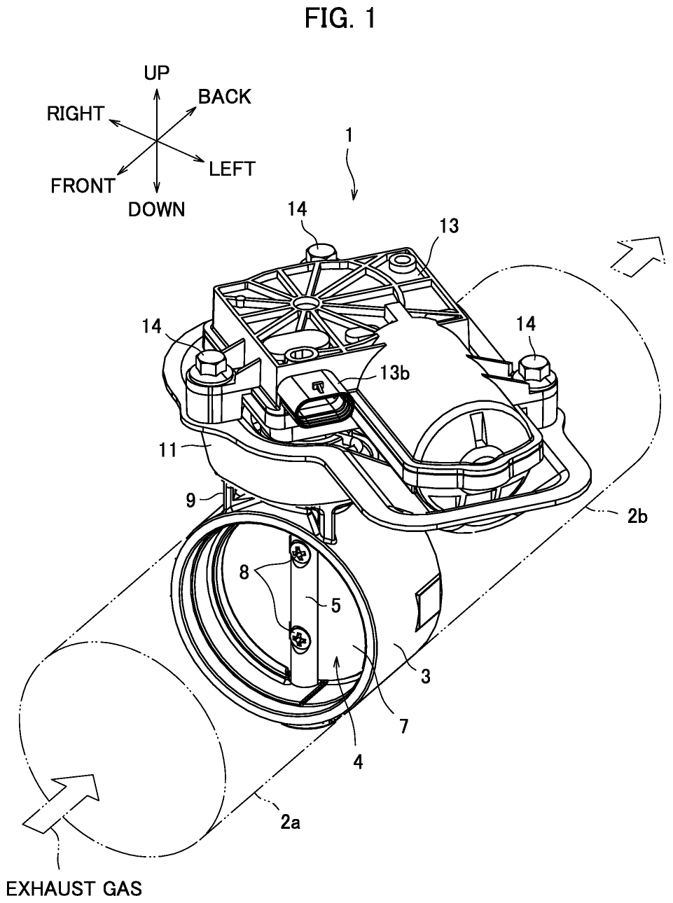

An exhaust valve device 1 is installed below a floor of a vehicle, which is not illustrated, in the posture illustrated in FIG. 1, and in the following description, front and back, left and right, and upper and lower directions will be expressed using the vehicle as a subject. Exhaust pipes 2a and 2b from an engine extend backward below the floor of the vehicle, the exhaust pipe 2a on the upstream side and the exhaust pipe 2b on the downstream side communicate with each other via an exhaust passage 4 formed in a valve body 3 of the exhaust valve device 1, and the exhaust pipe 2b on the downstream side is provided with a catalyst for purifying exhaust and a silencer although not illustrated.

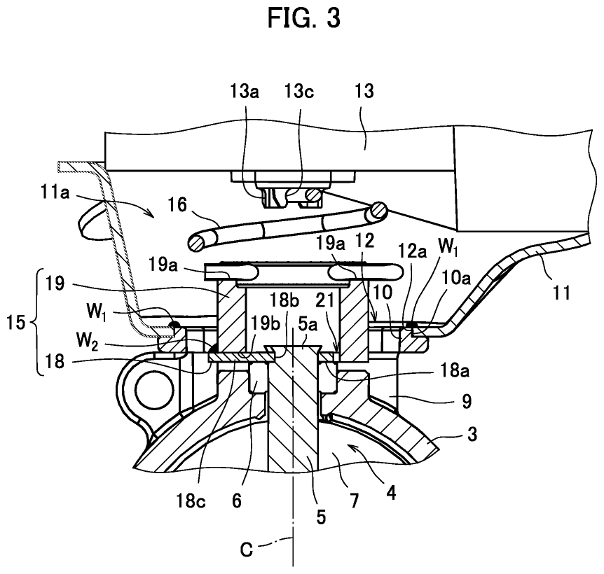

The valve body 3 is produced through casting, and a material with high heat resistance such as stainless steel is used. As illustrated in FIGS. 1 to 3, a rotating shaft 5 is disposed in the exhaust passage 4 with a circular sectional shape of the valve body 3, and an upper portion and a lower portion thereof are axially supported by hearings 6 (only the upper one is illustrated in FIG. 3) to be able to be turned. A valve element 7 with a disc shape is secured to the rotating shaft 5 in the exhaust passage 4 with a pair of screws 8, and the exhaust passage 4 is opened and closed by the valve element 7 in response to turning of the rotating shaft 5.

A base portion 9 for securing a thermal insulation bracket 11 and a motor unit 13, which will be described later, is integrally formed above the valve body and an upper end of the rotating shaft 5 projects upward at the center of the base portion 9. A circular projection 10 with an annular shape around an axial line C of the rotating shaft 5 at the center is provided above the base portion 9 to project therefrom, and surfaces thereof facing an outer circumferential side are used as outer circumferential guide surfaces 10a. The outer circumferential guide surfaces 10a correspond to a guide portion or a guide surface of the present invention. The outer circumferential guide surfaces 10a. are parts split on the left side and the right side, each of which has an arc shape around the axial line C of the rotating shaft 5 at the center respectively, by a front portion and a back portion of the circular projection 10 being linearly chamfered in accordance with the front-back length of the valve body 3.

As will be described below, the outer circumferential guide surfaces 10a play an important role in guiding the angle at which the motor unit 13 is secured to the valve body 3 and requires high precision in terms of the shape. Therefore, the left and right outer circumferential guide surfaces 10a are formed in the outer periphery of the circular projection 10 with an annular shape, and in other words, deformation such as falling of the outer circumferential guide surfaces 10a at the time of casting is curbed by the left and right portions of the outer circumferential guide surfaces 10a being coupled to each other via the linearly chamfered locations formed before and after the circular projection 10. Also, since it is difficult to smoothly guide the securing angle of the motor unit 13 with no change from the casting surface obtained by the casting, cutting is performed on each outer circumferential guide surface 10a after the casting. However, in a case in which no problems occur in the function of guiding the securing angle achieved by the outer circumferential guide surface 10a, left and right independent outer circumferential guide surfaces 10a may be provided above the base portion 9 to project therefrom, or the cutting performed on the outer circumferential guide surfaces 10a may be omitted.

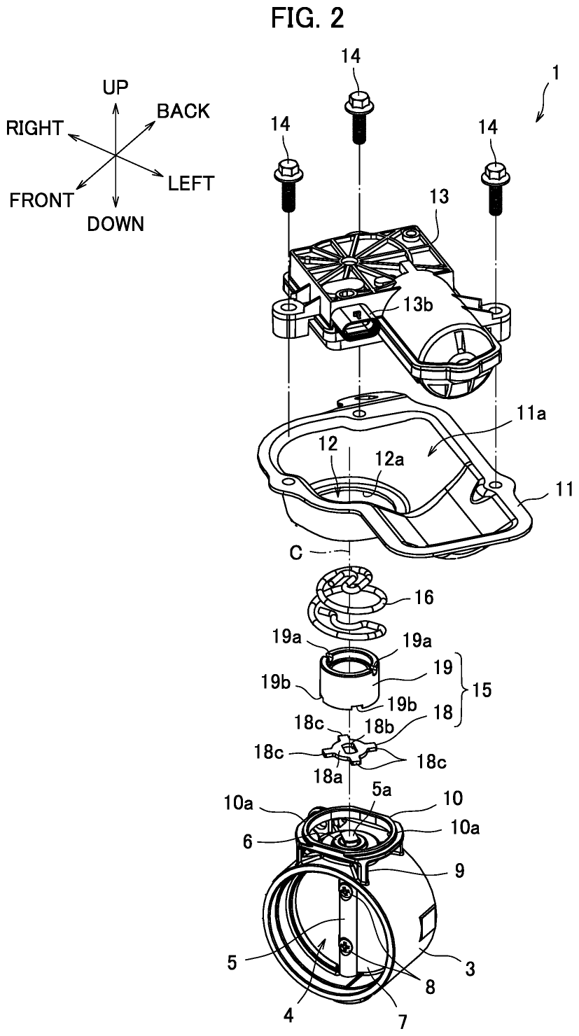

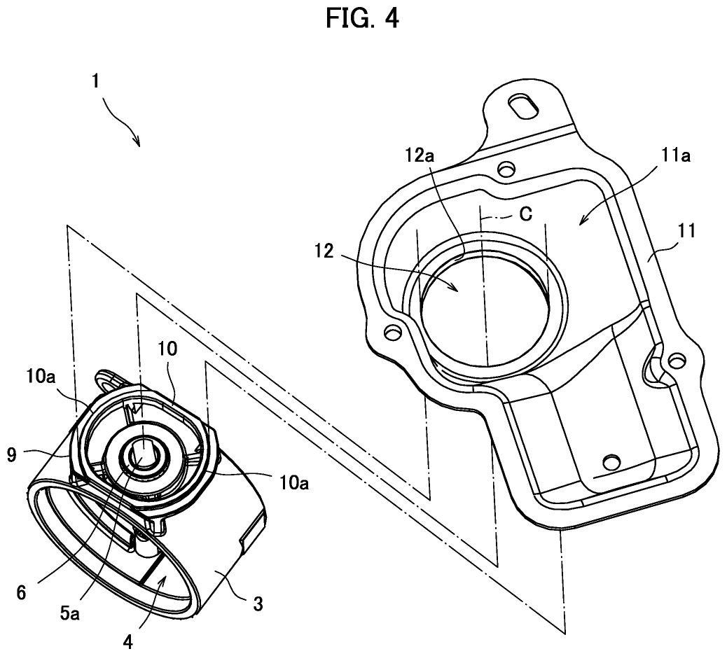

As illustrated in FIGS. 2 to 4, the thermal insulation bracket 11 as a bracket member of the present invention that is produced by press-molding a steel sheet is disposed above the valve body 3, such that the thermal insulation bracket 11 has a dish shape recessed upward. A circular hole 12 with an annular shape is provided on one side of the thermal insulation bracket 11 to penetrate therethrough at the time of the press-molding, such that the surface facing the inner circumferential side thereof is used as an inner circumferential guide surface 12a. The inner circumferential guide surface 12a corresponds to a guide portion or a guide surface of the present invention.

The circular hole 12 of the thermal insulation bracket 11 is fitted onto the circular projection 10 of the valve body 3, and the inner diameter of the circular hole 12 conforms to the outer diameter formed by the pair of outer circumferential guide surfaces 10a on the side of the valve body 3. Therefore, it is possible to arbitrarily achieve a change to an angle of the thermal insulation bracket 11 relative to the valve body 3 around the axial line C of the rotating shaft 5 at the center while bringing the inner circumferential guide surface 12a into slide contact with the outer circumferential guide surfaces 10a. Also, the thermal insulation bracket 11 is secured to the valve body 3 by the circular projection 10 and the inner circumferential edge of the circular hole 12 being spot-welded (illustrated as W1 in FIG. 3) after a prescribed securing angle is obtained.

Note that since the up-down dimension of the circular projection 10 conforms to the thickness of the thermal insulation bracket 11 in the embodiment, the circular projection 10 and the inner circumferential edge of the circular hole 12 are groove-welded. However, fillet-welding may be performed instead. Specifically, it is only necessary to increase the up-down dimension of the circular projection 10 to be greater than the thickness of the thermal insulation bracket 11 and to perform welding on a thus formed corner. Also, the spot-welding may be performed only at one location or may be performed at two locations facing at 180° around the axial line C of the rotating shaft at the center, or alternatively, riveting may be performed instead of the spot-welding to bond therebetween, as long as prescribed bonding strength can be obtained.

The motor unit 13 as an actuator of the present invention is disposed above the thermal insulation bracket 11 and is secured thereto with three bolts 14, and an output shaft 13a of the motor unit 13 oriented downward is disposed on the axial line C of the rotating shaft 5 to face the upper end of the rotating shaft 5 at a predetermined interval in the thermal insulation bracket 11. Although not illustrated, the motor unit 13 incorporates a motor and a deceleration mechanism, such that the motor is operated through power supply via a connector 13b provided on one side and the rotation thereof is decelerated by the deceleration mechanism to drive and rotate the output shaft 13a.

As will be described below in detail, the output shaft 13a of the motor unit 13 and the rotating shaft 5 of the valve body 3 are coupled to each other via a rigid joint member 15 and a flexible joint member 16. Rotation of the output shaft 13a of the motor unit 13 is transmitted to the rotating shaft 5 via each of the joint members 15 and 16, and the valve element 7 is driven to be opened or closed, thereby restricting exhaust gas distributed through the exhaust pipes 2a and 2b.

As illustrated in FIGS. 2 and 3, the rigid joint member 15 is obtained by bonding a sealing element 18 with a flat plate shape and a transmission element 19 with a tubular shape through welding, and a material with high heat resistance such as stainless steel is used. An axial hole 18b is provided in a sealing surface 18a of the sealing element 18 to penetrate therethrough, and arm portions 18c are provided to extend from four locations equally dividing the periphery of the sealing surface 18a. The upper end of the rotating shaft 5 projecting from the above of the base portion 9 of the valve body 3 is fitted into and riveted to the axial hole 18b of the sealing element 18, and the sealing element 18 is thus secured to the upper end of the rotating shaft 5.

The sealing surface 18a of the sealing element 18 abuts, from the upper side, the axially supported location above the valve body 3 and seals a minute clearance formed by the bearings 6 to prevent exhaust gas distributed in the exhaust passage from leaking. The transmission element 19 is disposed above the sealing element 18 from the upper side, and the rigid joint member 15 is formed by each of arm portions 18c of the sealing element 18 being fitted into and welded to engagement grooves 19b formed at a lower end of the transmission element 19.

The flexible joint member 16 is produced by spirally winding a wire material such as a piano wire, an upper end thereof is fitted into a spring groove 13c formed in the output shaft 13a, and a lower end thereof fitted into a spring groove 19a formed at an upper end of the transmission element of the rigid joint member 15. The flexible joint member 16 is interposed with elasticity between the output shaft 13a and the rigid joint member 15, thereby preventing dropping from a prescribed disposition state.

The flexible joint member 16 has a spiral shape and thus has both thermal insulation properties and flexibility. Also, heat transmission from the valve body 3 that has been excessively heated due to high-temperature exhaust gas to the motor unit 13 is insulated due to the thermal insulation properties of the flexible joint member 16, and along with insulation of radiant heat from the valve body 3 achieved by the thermal insulation bracket 11, which will be described later, an effect of protecting the motor unit 13 from heat damage is obtained. Also, the flexibility of the flexible joint member 16 has an effect of absorbing slight deviation of the axial line C between the rigid joint member 15 side and the output shaft 13a side.

The exhaust valve device 1 configured as described above is assembled in the following procedure, for example.

The individual components such as the sealing element 18, the transmission element 19, the rotating shaft 5, and the flexible joint member 16 are produced in advance, and then, first, the upper end of the rotating shaft 5 is inserted into the axial hole 18b of the sealing element 18 and is bonded thereto through riveting. Then, the transmission element 19 is disposed above the sealing element 18, and each of the arm portions 18c of the sealing element 18 is fitted into and welded with each of the engagement grooves 19b of the transmission element 19, thereby completing the rigid joint member 15. If the rotating shaft 5 is inserted into the bearings 6 of the valve body 3 from the upper side, then the sealing surface 18a. of the rigid joint member 15 abuts on the axially supported portion on the upper side, and in this state, the valve element 7 is secured to the rotating shaft 5 in the exhaust passage 4 with the screws 8.

Next, the circular hole 12 of the thermal insulation bracket 11 is fitted onto the circular projection 10 of the valve body 3. Each outer circumferential guide surface 10a of the circular projection 10 is brought into close contact with the inner circumferential guide surface 12a of the circular hole 12, and it is possible to achieve an arbitrary change to the angle of the thermal insulation bracket 11 relative to the valve body 3 by bringing the outer circumferential guide surface 10a and the inner circumferential guide surface 12a into slide contact with each other around the axial line C of the rotating shaft 5 at the center. For the operation of adjustment to a prescribed securing angle, a jig produced in advance is used. Although not illustrated, if the valve body 3 and the thermal insulation bracket 11 are set in the jig, the positional relationship therebetween is maintained at the prescribed securing angle by themselves, and in this state, the circular projection 10 of the valve body 3 and the inner circumferential edge of the circular hole 12 of the thermal insulation bracket 11 are spot-welded from the upper side.

Thereafter, the flexible joint member 16 is disposed above the transmission element 19 of the rigid joint member 15, and the motor unit 13 is disposed above the thermal insulation bracket 11 from the upper side and is secured thereto with the bolts 14. In this manner, the flexible joint member 16 is interposed with elasticity between the output shaft 13a of the motor unit 13 and the transmission element 19 of the rigid joint member 15, thereby completing the operation of assembling the exhaust valve device 1. It is a matter of course that the procedure of the assembly operation is not limited thereto and can be arbitrarily changed.

As described above, according to the exhaust valve device 1 of the present embodiment, it is possible to arbitrarily guide the angle at which the motor unit 13 is secured to the valve body 3 around the axial line C of the rotating shaft 5 at the center through the slide contact between the outer circumferential guide surfaces 10a on the side of the valve body 3 and the inner circumferential guide surface 12a on the side of the thermal insulation bracket 11. Since the securing angle of the motor unit 13 is changed around the axial line C of the rotating shaft 5 at the center, it is possible to constantly maintain the motor unit 13 in an accurate positional relationship with the valve body 3, specifically, in a positional relationship in which the axial line C of the rotating shaft 5 and the axial line C of the output shaft 13a are made to conform to each other, even if the securing angle changes. Since the inner circumferential guide surface 12a on the side of the thermal insulation bracket 11 has the annular shape in the embodiment, in particular, it is possible to address any securing angle within 360°.

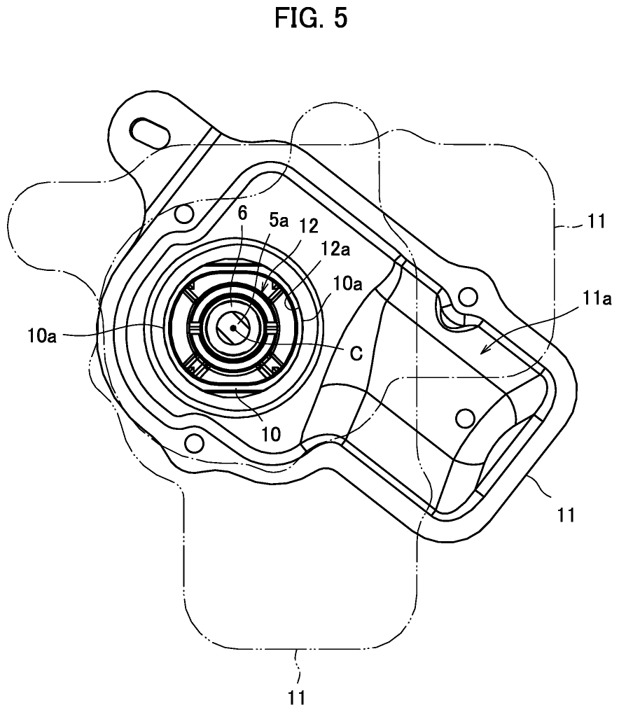

Thus, in a case in which the securing angle of the motor unit 13 illustrated by the solid line in FIG. 5 is changed to the securing angle illustrated by the one-dotted dashed line or to the securing angle illustrated by the two-dotted dashed line, for example, to adapt to vehicle-side installation conditions for installation in a different vehicle, it is possible to address the change merely by achieving the bonding at the prescribed securing angle using a jig corresponding to each securing angle. Also, even in a case in which it is determined to be necessary to perform trial installation in a vehicle at an original securing angle and to slightly perform fine adjustment, this can be completed merely by producing a jig again in accordance with the securing angle after the fine adjustment. In any case, it is possible to use the current thermal insulation bracket 11 without newly producing the entire thermal insulation bracket 11, and it is a matter of course that the same members can be used as the valve body 3 and the motor unit 13. Therefore, it is possible to address the assembly with a simple specification change of changing only the angle at which the thermal insulation bracket 11 is secured to valve body 3 without leading to an increase in costs.

In addition, since the thermal insulation bracket 11 is produced by press-molding a steel sheet, the advantages described below can be achieved.

First, the thermal insulation bracket 11 is formed into a dish shape recessed upward to cover the motor unit 13 from the lower side through press-molding using a steel sheet as a material. The shape is a shape suitable for insulating radiant heat from the valve body 3 located on the lower side, and also, it is possible to further achieve manufacturing cost reduction and weight reduction as compared with a case in which the thermal insulation bracket 11 is produced through cutting, for example.

Therefore, the radiant heat from the valve body 3 that has been excessively heated by exhaust gas is effectively insulated by the thermal insulation bracket 11 by the thermal insulation bracket 11 having the motor unit accommodation portion 11a that is an actuator accommodation portion with a recessed shape and being interposed between the valve body 3 and the motor unit 13 to cover the one side surface of the motor unit 13 in this manner. As a result, the motor unit 13 is protected from heat damage, and it is thus possible to improve reliability of the exhaust valve device 1. Also, the fact that the thermal insulation bracket 11 does not have a large size leads to a size reduction of the exhaust valve device 1, installation of the exhaust valve device 1 below a floor of a vehicle with a small spatial margin is facilitated, and it is thus possible to improve properties of installation in the vehicle.

Although it is more difficult to form clear shapes at corners and the like of the thermal insulation bracket 11 produced through press-molding as compared with the case of employing cutting, for example, the disadvantage is covered by forming the inner circumferential guide surface 12a on the side of the thermal insulation bracket 11.

In other words, to accurately guide the securing angle of the motor unit 13, it is necessary to fit the outer circumferential guide surfaces 10a of the valve body 3 and the inner circumferential guide surface 12a of the thermal insulation bracket 11 to each other in normal postures and to accurately cause the axial line C of the rotating shaft 5 and the axial line C of the output shaft 13a to conform to each other. In a case in which the inner circumferential guide surface 12a is formed in the valve body 3, and the outer circumferential guide surfaces 10a are formed in the thermal insulation bracket 11, a corner at the base end of the circular projection 10 provided through press-molding at the thermal insulation bracket 11 to project therefrom is formed into an R shape. The R-shaped corner may prevent the fitting to the inner circumferential guide surface 12a on the side of the valve body 3 in the normal posture, and in that case, deviation may occur between the axial line C of the rotating shaft 5 and the axial line C of the output shaft 13a.

The inner circumferential guide surface 12a in the embodiment is an inner circumferential surface of the circular hole 12 provided in the thermal insulation bracket 11 to penetrate therethrough, and the circular hole 12 is punched into a prescribed circular shape at the time of the press-molding unlike the R-shaped corner described above. On the other hand, the circular projection 10 on the counterpart side is casted along with the valve body 3 and has a prescribed clear shape. Therefore, it is possible to fit the inner circumferential guide surface 12a to the outer circumferential guide surfaces 10a. in a normal posture and to accurately cause the axial line C of the rotating shaft 5 and the axial line C of the output shaft 13a to conform to each other, and as a result, it is possible to accurately guide the securing angle of the motor unit 13. Also, it is possible to produce the thermal insulation bracket 11 through press-molding that can be simply performed after such various conditions (heat insulation properties, size reduction, and the inner circumferential guide surface 12a with a prescribed shape) required by the thermal insulation bracket 11 are achieved, and this factor also significantly contributes to manufacturing cost reduction.

Aspects of the present invention are not limited to this embodiment. Although the aforementioned embodiment is implemented as the exhaust, valve device 1 for a four-wheel vehicle, the present invention may be applied to an exhaust valve device for a two-wheel vehicle or a three-wheel vehicle instead, for example.

Also, although the circular projection 10 is formed on the side of the valve body 3, the circular hole 12 is formed on the side of the thermal insulation bracket 11, and the securing angle is guided through slide contact between the guide surfaces 10a and 12a of the circular projection 10 and the circular hole 12 in the aforementioned embodiment, the circular hole 12 may be formed on the side of the valve body 3, and the circular projection 10 may be formed on the side of the thermal insulation bracket 11 in an opposite manner.

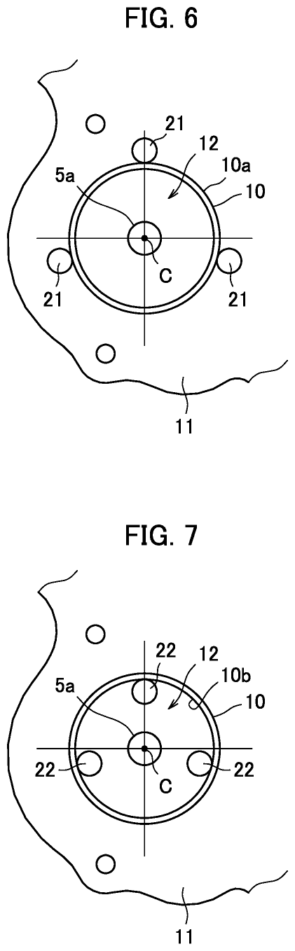

Also, the guide surfaces 10a and 12a are not necessarily formed on both the side of the valve body 3 and the side of the thermal insulation bracket 11 for the function of guiding the securing angle. For example, three guide pins 21 may be provided on the side of the thermal insulation bracket 11 to stand downward as illustrated in FIG. 6, and the securing angle may be guided by bringing these guide pins 21 into slide contact with the outer circumferential guide surfaces 10a. of the circular projection 10 of the valve body 3. Also, the inner circumferential surface of the circular projection 10 of the valve body 3 may be used as an inner circumferential guide surface 10b as illustrated in FIG. 7, three guide pins 22 provided on the side of the thermal insulation bracket 11 to stand therefrom may be brought into slide contact with the inner circumferential guide surface 10b, and even in this case, a similar guiding function is obtained. In both FIGS. 6 and 7, the interval of each of the guide pins 21 and 22 around the axial line C of the rotating shaft 5 at the center is set to be smaller than 180° to maintain the slide contact state of each of the guide pins 21 and 22 with respect to the outer circumferential guide surfaces 10a and the inner circumferential guide surface 10b. The guide pins 21 and 22 in these different examples correspond to the guide portion of the present invention.

Note that the numbers of the guide pins 21 and 22 are not limited to three and may be to an arbitrary number. Also, the guide surfaces 10a and 10b may be formed on the side of the thermal insulation bracket 11 in a manner opposite to that in FIGS. 6 and 7, and the guide pins 21 and 22 may be formed on the side of the valve body 3.

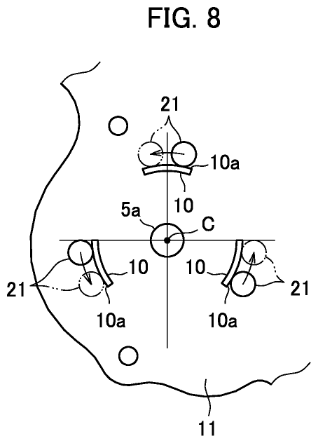

In addition, the guide surfaces 10a and 10b may be formed only in regions with which the guide pins 21 and 22 are brought into slide contact. In a case in which the motor unit 13 is secured at two angles illustrated in FIG. 8 using the guide pins 21 of the solid line and the two-dotted dashed line in the configuration in which the outer circumferential guide surfaces 10a are formed as illustrated in FIG. 6, for example, the outer circumferential guide surfaces 10a may be formed only in a region between these angles. Although not illustrated, the same applies to the case of the inner circumferential guide surface 10b illustrated in FIG. 7.

### REFERENCE SIGNS LIST

1 Exhaust valve device
3 Valve body
4 Exhaust passage
5 Rotating shaft
10 Circular projection
10a Outer circumferential guide surface (guide portion, guide surface)
11 Thermal insulation bracket (bracket member)
11a Motor unit accommodation portion (actuator accommodation portion)
12 Circular hole
12a Inner circumferential guide surface (guide portion, guide surface)
13 Motor unit (actuator)
13a Output shaft
21, 22 Guide pin (guide portion)

What is claimed is:

1. An exhaust valve device for a vehicle in which a valve element is supported to be able to be opened and closed in an exhaust passage by a rotating shaft axially supported by a valve body, an actuator is attached to the valve body via a bracket member, and an output shaft of the actuator is coupled to the rotating shaft, the exhaust valve device comprising:
a guide surface provided at one of the valve body and the bracket member and having an arc shape around an axial line or the rotating shaft at the center; and
a guide portion provided at the other one of the valve body and the bracket member and brought into slide contact with the guide surface to guide the bracket member to be secured at a prescribed securing angle to the valve body around the axial line of the rotating shaft at the center.

2. The exhaust valve device for a vehicle according to claim 1,
wherein the guide surface is formed as an outer circumferential guide surface facing an outer circumferential side, and
the guide portion is formed as an inner circumferential guide surface having an arc shape around the axial line or the rotating shaft at the center and facing an inner circumferential side.

3. The exhaust valve device for a vehicle according to claim 2, wherein at least one of the outer circumferential guide surface and the inner circumferential guide surface has an annular shape.

4. The exhaust valve device for a vehicle according to claim 1,
wherein the guide surface is formed as an outer circumferential guide surface facing an outer circumferential side, and
the guide portion is formed as a plurality of guide pins provided to stand from the other one of the valve body and the bracket member and brought into slide contact with the outer circumferential guide surface.

5. The exhaust valve device for a vehicle according to claim 1,
wherein the guide surface is formed as an inner circumferential guide surface facing an inner circumferential side, and
the guide portion is formed as a plurality of guide pins provided to stand from the other one of the valve body and the bracket member and brought into slide contact with the inner circumferential guide surface.

6. The exhaust valve device for a vehicle according to claim 1, wherein the bracket member has a recessed dish-shaped actuator accommodation portion and is interposed between the valve body and the actuator to cover one side surface of the actuator.

7. The exhaust valve device for a vehicle according to claim 6,
wherein the valve body is produced through casting,
the guide surface is formed as an outer circumferential surface of a circular projection provided at the valve body to project therefrom at the time of the casting,
the bracket member is produced by press-molding a steel sheet, and
the guide portion is formed as an inner circumferential surface of a circular hole provided on one side of the bracket member to penetrate therethrough at the time of the press-molding.
